(19) United States
(12) Patent Application Publication
(10) Pub. No.: US 2025/0328036 A1
(43) Pub. Date: Oct. 23, 2025

(54) Optical Modulator and Optical Transmission Device Using Same

(71) Applicant: SUMITOMO OSAKA CEMENT CO., LTD., Tokyo (JP)

(72) Inventors: Yumi MURATA, Tokyo (JP); Kosuke OKAHASHI, Tokyo (JP); Shotaro HIRATA, Tokyo (JP)

(73) Assignee: SUMITOMO OSAKA CEMENT CO., LTD., Tokyo (JP)

(21) Appl. No.: 18/871,416

(22) PCT Filed: Sep. 30, 2022
(86) PCT No.: PCT/JP2022/036753

§ 371 Date: Dec. 3, 2024

(51) Int. Cl. G02F 1/03

(52) U.S. Cl. CPC G02F 1/0316; G02F 2202/20

(57) ABSTRACT

An object of the present invention is to provide an optical modulator that suppresses progressing of over-etching and prevents an increase in a drive voltage and electrode peeling. The optical modulator of the present invention includes a substrate 1 on which an optical waveguide 10 is formed, an electrode 2 disposed close to the optical waveguide on the substrate, and an electrode underlayer 3 formed between the substrate 1 and the electrode 2. A surface side of the substrate 1 has an uneven portion 5 in a predetermined range S2 entering an inside of the electrode from an end portion of the electrode 2 close to the optical waveguide when the substrate is viewed in a plan view.

### TECHNICAL FIELD

The present invention relates to an optical modulator and an optical transmission apparatus using the same, and particularly relates to an optical modulator including a substrate on which an optical waveguide is formed and an electrode disposed close to the optical waveguide on the substrate, and having an electrode underlayer formed between the substrate and the electrode, and to an optical transmission apparatus using the same.

### BACKGROUND ART

In an optical measurement technology field and an optical communication technology field, an optical modulator using a substrate on which an optical waveguide is formed is widely used. In a general optical modulator, an optical waveguide is formed on a substrate of lithium niobate (LN) or the like having an electro-optic effect, and an electrode that applies an electric field to the optical waveguide is formed on the substrate.

In recent years, a high bandwidth-coherent driver modulator (HB-CDM) has attracted attention, and as shown in FIG. 1, a rib-type waveguide having a width and a height of approximately 1 μm is used for an optical waveguide 10 formed on a substrate 1. This micro rib-type waveguide has strong confinement of light, can bend the optical waveguide with a small curvature, and can form the optical modulator in a compact manner.

In this optical modulator, an interval GAP between electrodes that apply the electric field to the optical waveguide, for example, an interval between a signal electrode and a ground electrode or an interval between DC bias electrodes, is reduced from several tens of μm in the related art to several μm, and an electrode interval is extremely narrowed. Furthermore, a thickness of the electrode is also reduced from several tens of μm to several μm.

On the other hand, as disclosed in Patent Literature 1, the electrode of the general optical modulator adopts a configuration in which an electrode underlayer 3 for fixing a LN substrate 1 and an Au electrode 2 is interposed between the LN substrate 1 and the Au electrode 2. Therefore, an electrode shape (shapes of the electrode underlayer 3 and an electrode (electrode material layer) 2 on the electrode underlayer 3) is determined by the following process. First, the electrode underlayer and a layer formed of the same material as the electrode material (Au or Cu) are formed on the substrate by means of sputtering or vapor deposition, and the electrode is formed by means of plating or vapor deposition. Thereafter, the electrode material layer and the electrode underlayer which do not relate to electrode portions are etched with different etching solutions, and the electrode is formed. A reference numeral 4 is a reinforcing substrate that supports the substrate 1.

However, when the electrode underlayer is etched, as shown in FIG. 2, there is a problem in that the electrode underlayer 3 becomes an over-etching portion 30 due to a capillary action. In particular, as a size of the optical modulator is reduced, the electrode and the optical waveguide are brought close to each other, and light absorption is increased by the electrode underlayer. When the electrode underlayer is thinly formed to suppress the light absorption in the electrode underlayer, on the contrary, over-etching is likely to progress. The amount of the over-etching usually progresses to approximately several μm. When the electrode underlayer is over-etched, a substantial distance between the optical waveguide and the electrode is widened. In this manner, a drive voltage increases. As an example, the electrode interval is set to 10 μm or shorter as the size of the optical modulator is reduced, and it is preferable that the electrode interval is set to 5 μm or shorter to further reduce the drive voltage. For example, when the electrode interval is 5 μm, and when the amount of the over-etching progresses by approximately 2 μm on one side, the electrode interval is substantially widened to 9 μm (approximately twice a design value), and the drive voltage is significantly increased.

In addition, due to the over-etching, a problem arises in that electrode peeling occurs since a grounding area of the electrode is reduced. As shown in FIGS. 1 and 2, a target of the grounding area between the substrate 1 and the electrode 2 is usually within a range indicated by an arrow SO. FIG. 2 shows the vicinity of the optical waveguide 10. Therefore, a left end of SO is intermediately cut off and displayed. However, as shown in FIG. 1, the electrode 2 may further extend to a left side in some cases. When an area ratio of a range S1 (area derived from a range indicated by S1 and a length of the electrode in a longitudinal direction) in which the over-etching has progressed, to a range SO (area derived from a range indicated by SO and the length of the electrode in the longitudinal direction) exceeds 50%, peeling of the electrode is significant. In addition, when a size of the range S1 is equal to or larger than 1 time a thickness HE of the electrode, particularly 2 times or larger, the peeling is likely to progress. As a matter of course, the over-etching of the electrode underlayer 3 not only occurs on a side of the optical waveguide 10 in FIG. 1 or FIG. 2, but also in the vicinity of an opposite side end portion.

In particular, in a case of the size-reduced optical modulator such as HB-CDM, the grounding area of the electrode (range SO in FIG. 2) becomes smaller than that of a product in the related art (SO is approximately 10 μm). Therefore, for example, when the over-etching progresses by approximately 2 μm, joint strength of the electrode to the substrate becomes extremely weakened.

In addition, when the thickness HE of the electrode is approximately 1 μm, and when the over-etching progresses by approximately 2 μm, the peeling of the electrode is likely to occur.

### CITATION LIST

### Patent Literature

[Patent Literature No. 1] Japanese Laid-open Patent Publication No. 2000-275588 (JP2000-275588A)

### SUMMARY OF INVENTION

### Technical Problem

An object to be achieved by the present invention is to provide an optical modulator that solves the above-described problems, suppresses progressing of over-etching, and prevents an increase in a drive voltage and electrode peeling. Furthermore, another object of the present invention is to provide an optical transmission apparatus using the optical modulator.

### Solution to Problem

In order to achieve the above-described object, an optical modulator according to the present invention, and an optical transmission apparatus using the same, have the following technical characteristics.

(1) An optical modulator includes a substrate on which an optical waveguide is formed, an electrode disposed close to the optical waveguide on the substrate, and an electrode underlayer formed between the substrate and the electrode. A surface side of the substrate has an uneven portion in a predetermined range entering an inside of the electrode from an end portion of the electrode close to the optical waveguide when the substrate is viewed in a plan view.

(2) In the optical modulator according to (1), the optical waveguide is a rib-type waveguide.

(3) In the optical modulator according to (2), a maximum height of a protruding portion in the uneven portion is equal to or lower than a height of the rib-type waveguide.

(4) In the optical modulator according to (2), a maximum width of a protruding portion in the uneven portion is equal to or smaller than a width of the rib-type waveguide.

(5) In the optical modulator according to (1), two or more protruding portions are disposed in parallel in the uneven portion.

(6) The optical modulator according to any one of (1) to (5) further includes a case that accommodates the substrate, and an optical fiber that inputs a light wave to the optical waveguide, or outputs the light wave from the optical waveguide.

(7) In the optical modulator according to (6), the electrode is a modulation electrode for modulating the light wave propagating through the optical waveguide, and an electronic circuit that amplifies a modulation signal to be input to the modulation electrode is provided inside the case.

(8) An optical transmission apparatus includes the optical modulator according to (7), a light source that inputs a light wave to the optical modulator, and an electronic circuit that outputs a modulation signal to the optical modulator.

### Advantageous Effects of Invention

According to the present invention, an optical modulator includes a substrate on which an optical waveguide is formed, an electrode disposed close to the optical waveguide on the substrate, and an electrode underlayer formed between the substrate and the electrode, a surface side of the substrate has an uneven portion in a predetermined range entering an inside of the electrode from an end portion of the electrode close to the optical waveguide when the substrate is viewed in a plan view. Therefore, the uneven portion can suppress etching of the electrode underlayer, and can suppress progressing of over-etching. As a result, an increase in a drive voltage and electrode peeling can be prevented.

Furthermore, since the optical modulator having these excellent characteristics is used, it is possible to provide an optical transmission apparatus that achieves the same advantageous effects.

### BRIEF DESCRIPTION OF DRAWINGS

FIG. 1 is a cross-sectional view showing an example of an optical modulator in the related art.

FIG. 2 is a cross-sectional view for describing a problem (over-etching) of the optical modulator in the related art.

FIG. 3 is a cross-sectional view showing a first embodiment of an optical modulator according to the present invention.

FIG. 4 is a cross-sectional view showing a second embodiment of the optical modulator according to the present invention.

FIG. 5 is a view showing a relationship between the cross-sectional view and a plan view of the optical modulator in FIG. 3.

FIGS. 6A and 6B are views showing an example in which a shape of an uneven portion formed on a surface of a substrate is changed.

FIG. 7 is a cross-sectional view showing a third embodiment of the optical modulator according to the present invention.

FIG. 8 is a view showing an example in which a buffer layer is disposed on the surface of the substrate.

FIG. 9 is a view showing an example of an optical transmission apparatus of the present invention.

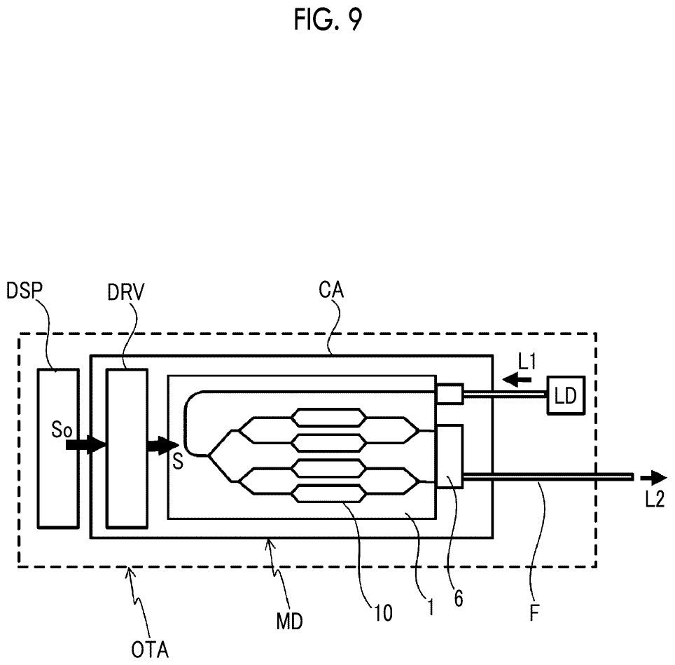

### DESCRIPTION OF EMBODIMENTS

Hereinafter, an optical modulator of the present invention will be described in detail with reference to suitable examples.

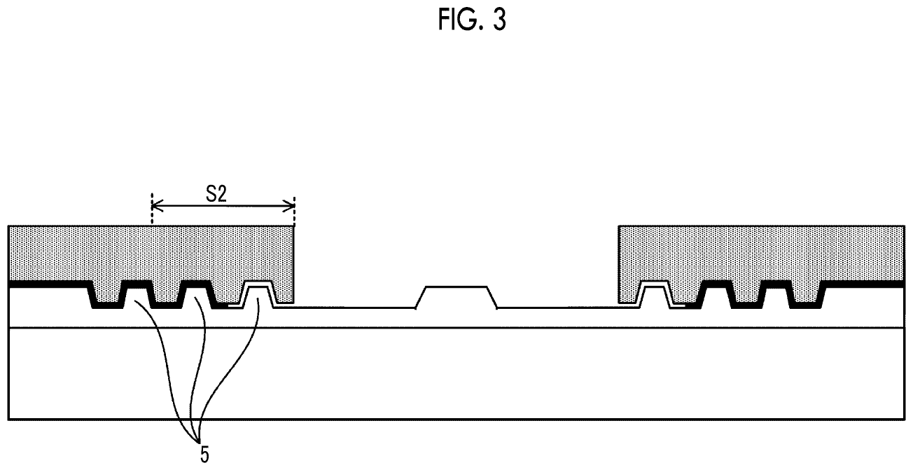

FIG. 3 is a cross-sectional view showing an example of the optical modulator of the present invention.

The optical modulator of the present invention includes a substrate 1 on which an optical waveguide 10 is formed, an electrode 2 disposed close to the optical waveguide on the substrate, and an electrode underlayer 3 formed between the substrate 1 and the electrode 2. A surface side of the substrate 1 has an uneven portion 5 in a predetermined range S2 entering an inside of the electrode from an end portion of the electrode 2 close to the optical waveguide when the substrate is viewed in a plan view.

As the substrate 1 used in an optical waveguide device of the present invention, a substrate having an electro-optic effect can be used. Specifically, substrates of lithium niobate (LN), lithium tantalate (LT), lead lanthanum zirconate titanate (PLZT), and the like or base materials obtained by doping these substrate materials with MgO or the like can be used. In addition, these materials can be formed into films by using a vapor-phase growth method such as a sputtering method, a vapor deposition method, or a CVD method. Furthermore, semiconductor substrates and the like can be used.

As the optical waveguide 10, it is possible to use an optical waveguide in which a high refractive index material such as Ti is thermally diffused in the substrate 1, an optical waveguide formed by using a proton exchange method, and further, a rib-type waveguide in which a portion corresponding to the optical waveguide is formed in a protruding shape in the substrate by etching the substrate 1 other than the optical waveguide or by forming grooves on both sides of the optical waveguide. Furthermore, a refractive index can become higher in such a manner that Ti or the like is diffused on a surface of the substrate by using a thermal diffusion method, a proton exchange method, or the like in accordance with the rib-type optical waveguide. As a size of the rib-type waveguide, a micro rib-type optical waveguide has a width and a height of approximately 1 μm to improve confinement of light.

In order to achieve velocity matching between a microwave of a modulation signal and the light wave, a thickness of the substrate (thin plate) 1 on which the optical waveguide 10 is formed is set to 10 μm or smaller, more preferably 5 μm or smaller, and still more preferably 1 μm or smaller. In addition, a height of the rib-type optical waveguide is set to 4 μm or lower, more preferably 3 μm or lower, and still more preferably 1 μm or lower or 0.4 μm or lower.

In the substrate 1 on which the optical waveguide is formed, a reinforcing substrate 4 is joined to a lower side of the substrate 1 to increase mechanical strength. The substrate 1 and the reinforcing substrate 4 are adhesively fixed by means of direct joining or through an adhesive layer of resin or the like. The reinforcing substrate to be directly joined preferably has a lower refractive index than the optical waveguide or than the substrate on which the optical waveguide is formed, but the configuration is not limited to this example. In addition, a substrate including an oxide layer of crystal, glass, or the like, for example, a material having a coefficient of thermal expansion which is close to a material of the substrate 1 is preferably used as the reinforcing substrate. Furthermore, the same LN substrate as the substrate 1, or a composite substrate obtained by forming a silicon oxide layer on a silicon substrate and a composite substrate obtained by forming a silicon oxide layer on a LN substrate, which are abbreviated to SOI and LNOI, can also be used.

The electrode formed on the substrate 1 uses metal such as Au or Cu. However, the electrode underlayer 3 such as a base electrode is disposed to improve close contact between the substrate 1 and the electrode 2. The thickness of the electrode underlayer 3 is set to 2 nm or larger to improve close contact between the substrate 1 and the electrode 2.

As a material for the electrode underlayer, Nb, Ti, Ni, or the like is used.

The thickness of the electrode underlayer is 30 nm or smaller, and is set to 15 nm or smaller, more preferably 5 nm or smaller to suppress a possibility that the light wave propagating through the optical waveguide is absorbed by the electrode underlayer.

The electrode underlayer is formed by using a sputtering method, a vapor deposition method, or the like, and thereafter, a thick electrode (electrode material layer) 2 is formed by using a plating method, a vapor deposition method, or the like.

According to characteristics of the optical modulator of the present invention, an uneven portion is formed on a surface side of the substrate 1 to suppress over-etching of the electrode underlayer. When the electrode underlayer is disposed along the uneven portion, etching progresses along the electrode underlayer. Therefore, the uneven portion induces an etching direction not only in a horizontal direction parallel to the surface of the substrate 1 but also in a vertical direction. As a result, progressing of the over-etching in the horizontal direction is suppressed. As a result of suppressing the over-etching, as shown in FIG. 3, the etching of the electrode underlayer 3 is intermediately stopped within a range where the uneven portion is formed. In addition, when the uneven portion is formed, an etched range (range entering an inside of the electrode from an end portion of the electrode) is narrowed, compared to when the uneven portion is not formed.

As a method of forming the uneven portion on the surface side of the substrate 1, as shown in FIG. 3, as in the method for forming the optical waveguide 10, the uneven portion (protruding portion 5) can be formed on the surface of the substrate by performing an etching process, a cutting process, an electron beam process, and the like on the substrate 1. As a matter of course, the uneven portion 5 can also be formed when the optical waveguide 10 is formed.

In addition, the uneven portion can also be formed on the substrate 1 by using a resin material, an inorganic dielectric material, or the like. For example, the uneven portion can also be formed by providing a pattern using a permanent resist or a metal oxide (SiO₂, Al₂O₃, or the like) on the surface of the substrate 1.

The predetermined range S2 in which at least the uneven portion is formed is set to a value satisfying all of the following conditions (1) to (3).

$$Smaller than interval GAP of Electrode \times 0.2 ( 20 \% ) \qquad ( Condition 1 )$$

$$Smaller than S 0 \times 0.5 ( 50 \% ) ( or Smaller than so \times 0.25 ( 25 \% ) ) \qquad ( Condition 2 )$$

(Condition 3) Smaller than Thickness HE of Electrode

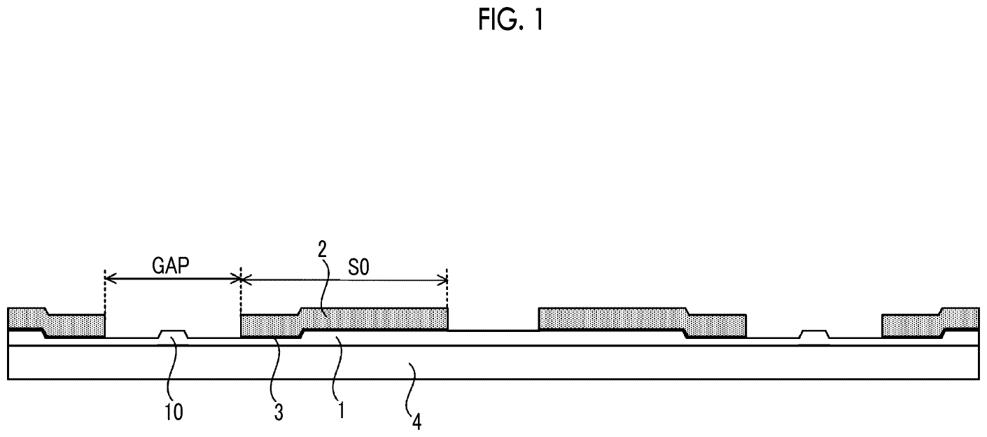

When the over-etching occurs only on one side of the electrode 2, Condition 2 is smaller than 50%, and when the over-etching occurs to the same extent from both sides of the range SO of the electrode 2 shown in FIG. 1, Condition 2 is smaller than 25%.

A meaning of setting the range S2 is to suppress progressing of the over-etching to be smaller than the range S2. In this manner, the following disadvantages can be eliminated.

For example, when the range S2 in which the uneven portion is formed is equal to or larger than the interval GAP of the electrode×0.2 (20%), a substantial distance between the optical waveguide and the electrode is widened due to the progressing of the over-etching, and the drive voltage increases. When the range S2 in which the uneven portion is formed is equal to or larger than S0×0.5 (50%), or when the thickness of the electrode is equal to or larger than HE, peeling of the electrode is likely to progress due to the progressing of the over-etching.

As a matter of course, in order to further suppress the progressing of the over-etching, a range in which the uneven portion is definitely set may be set to S2 or smaller. An additional uneven portion can also be provided in a range other than the predetermined range (portion entering the inside of the electrode). In this manner, not only is the progressing of the over-etching further suppressed, but also the grounding area between the electrode, the electrode underlayer, and the substrate is increased by the uneven portion, and joint strength of the electrode can be set higher.

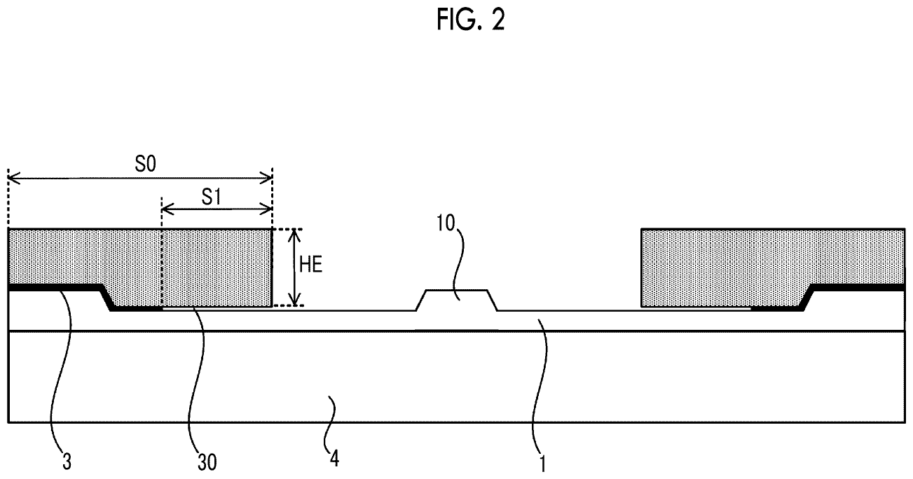

As described above, the over-etching causes a problem of the electrode peeling due to a decrease in the grounding area of the electrode. As shown in FIG. 2, it is preferable that an area ratio of a joining region (portion excluding the range S1 from the range SO) of the electrode underlayer, which remains without being over-etched to a joining region (range SO) of the same surface portion between the substrate 1 and the electrode 2, is set to 50% or larger. In addition, it is preferable that the range S1 to be over-etched is set to at least 2 times the thickness HE of the electrode or smaller, and more preferably at least 1 time or smaller. In order to realize these objects, the uneven portion 5 is disposed on the surface side of the substrate 1.

The height of the uneven portion (protruding portion) on the surface of the substrate 1 is set to 1 μm or lower. This height is substantially the same as the height of the rib-type waveguide 10, and when the optical waveguide 10 and the protruding portion 5 are close to each other, a phenomenon in which the light wave propagating through the optical waveguide 10 is transferred to the protruding portion 5 is likely to occur. In this manner, the phenomenon causes an increase in an optical propagation loss.

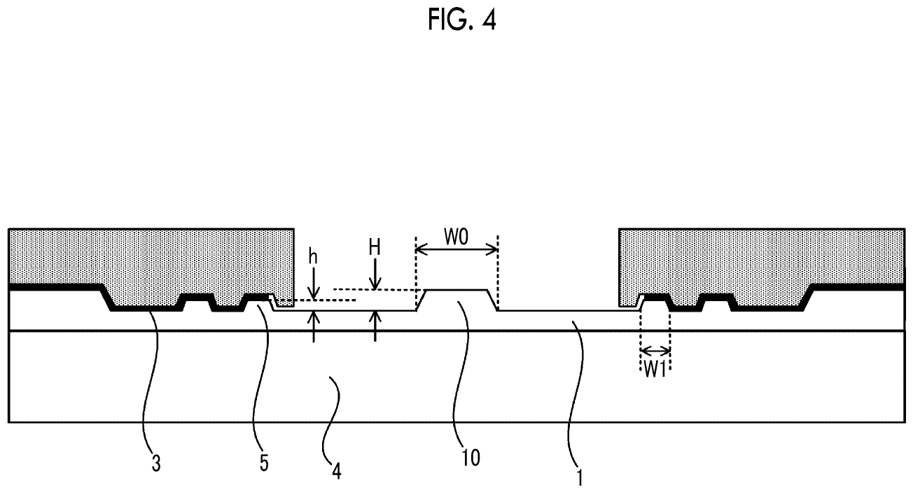

In order to suppress this disadvantage, as shown in FIG. 4, it is preferable to provide a difference in a shape (height or width) between the optical waveguide 10 and the protruding portion. A maximum height h of the protruding portion 5 is set to be equal to or lower than a height H of the rib-type waveguide 10, or a maximum width W1 of the protruding portion 5 is set to be equal to or smaller than a width W0 of the rib-type waveguide 10. For example, the height h of the protruding portion 5 is set to be equal to or lower than 50% of the height H of the optical waveguide 10, or the width W1 of the protruding portion 5 is set to be equal to or smaller than 50% of the width W0 of the optical waveguide 10.

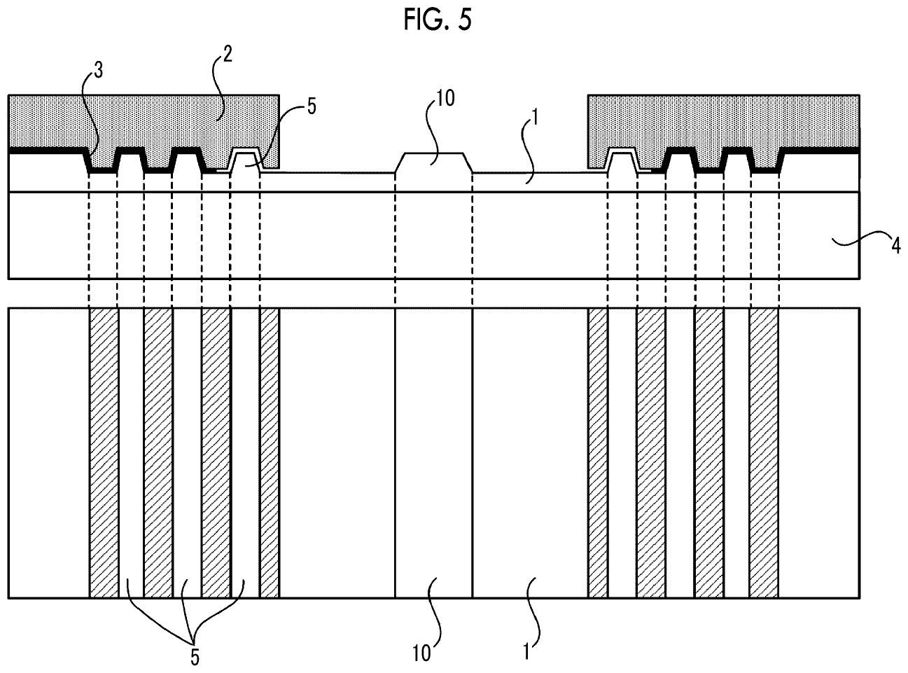

In addition, as shown in FIG. 5, as in the electrode 2 extending along the optical waveguide 10, the uneven portion (protruding portion 5) extends along the end portion (optical waveguide side) of the electrode 2. An upper half of FIG. 5 is the same cross-sectional view as that of FIG. 3, and a lower half of FIG. 5 is a plan view in which the protruding portion 5 is disposed in a plan view. As a matter of course, the protruding portion 5 is not exposed from the end portion of the electrode 2. The reason is to prevent a disadvantage that a shape of a side surface of the electrode 2 which faces the optical waveguide 10 is changed in the portion where the protruding portion is exposed, and an electric field to be applied to the optical waveguide is changed.

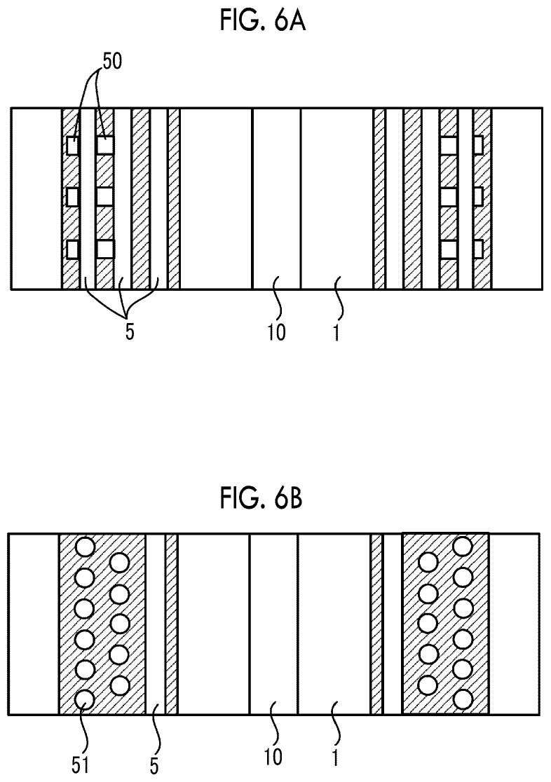

In addition, as shown in FIGS. 6A and 6B, as in the electrode 2 extending along the optical waveguide 10, the uneven portion (first protruding portion) 5 closest to the optical waveguide extends along the end portion (optical waveguide side) of the electrode 2. However, the second and subsequent protruding portions do not necessarily have to extend along the end portion of the electrode 2 as shown in the lower half of FIG. 5. For example, as shown in FIG. 6(a), the second and subsequent protruding portions may be a lattice pattern or the like. In this case, since the uneven portion increases to easily achieve an anchor effect, the peeling of electrode 2 can be suppressed. The protruding portion 5 disposed along the optical waveguide forming the lattice pattern and the protruding portion 50 disposed perpendicular to the extending direction of the optical waveguide may have the same height, or may have different heights.

Furthermore, as shown in FIG. 6(b), the second and subsequent protruding portions can be disposed as discrete protruding portions (for example, a columnar shape) 51.

FIGS. 6A and 6B show an application example of the lower half of FIG. 5.

As shown in FIGS. 3 to 7, a higher advantageous effect is achieved when a plurality of the protruding portions 5 are provided. For example, an advantageous effect of suppressing the over-etching by approximately 0.6 μm can be confirmed with one protruding portion 5. In addition, when the height of the protruding portion 5 is approximately 0.3 μm, the advantageous effect is achieved. As a matter of course, when the protruding portions are provided in the same range, it is preferable to more reliably suppress the over-etching by disposing two or more protruding portions 5 in parallel rather than one. For example, when there is one protruding portion, the advantageous effect of suppressing the over-etching is approximately 30% to 50%. In contrast, when there are two protruding portions, the advantageous effect of suppressing the over-etching is expected by 50% or higher. In addition, as shown in FIGS. 2 to 7, due to progressing of over-etching, there exists a region where the electrode underlayer 3 does not exist between the end portion (optical waveguide side) of the electrode 2 and the substrate 1, or in a portion between the electrode 2 and the uneven portion.

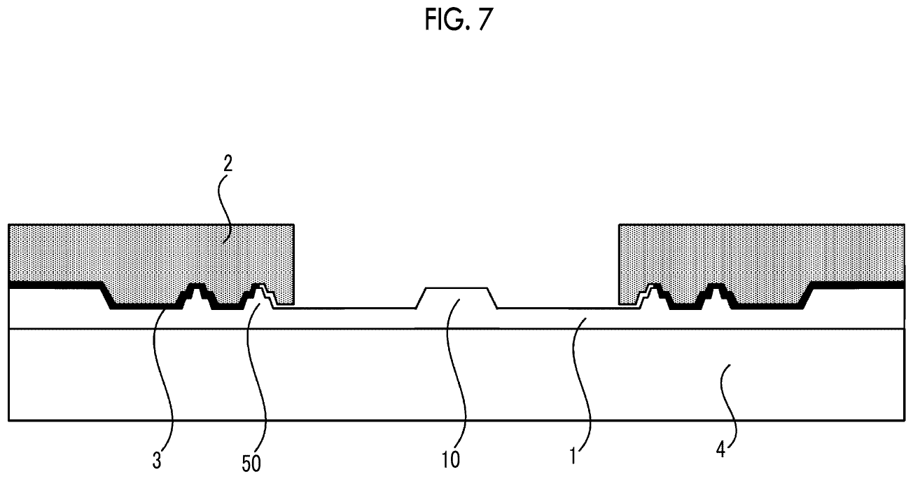

In addition, as a shape of the uneven portion, the protruding portion 50 having multiple stages as shown in FIG. 7 can be formed, in addition to forming the protruding portion having a rectangular shape or a trapezoidal shape as shown in FIG. 3 or the like. Since the protruding portion having multiple stages is formed in this way, the over-etching direction is changed in a complex way, and the advantageous effect of suppressing progressing of the over-etching can be improved. As the shape of the protruding portion, a configuration in which a recess portion is incorporated into an upper surface of the protruding portion can also be adopted, in addition to a configuration in which the protruding shapes are stacked in multiple stages.

In FIGS. 3 to 7, the protruding portion 5 (50) protruding on the surface of the substrate 1 is shown as an example. However, the uneven portion may be a recess portion recessed from the surface of the substrate 1. However, since the electrode underlayer 3 and the electrode 2 are located below the surface of the substrate 1 along the recess portion, there is a possibility that the light wave (signal light) passing through a portion below the surface of the substrate 1 (optical waveguide or the vicinity of the optical waveguide) is absorbed. Therefore, when the recess portion is formed, a bottom surface of the recess portion is configured to be located at the same height as the bottom surface of the optical waveguide or at a higher height.

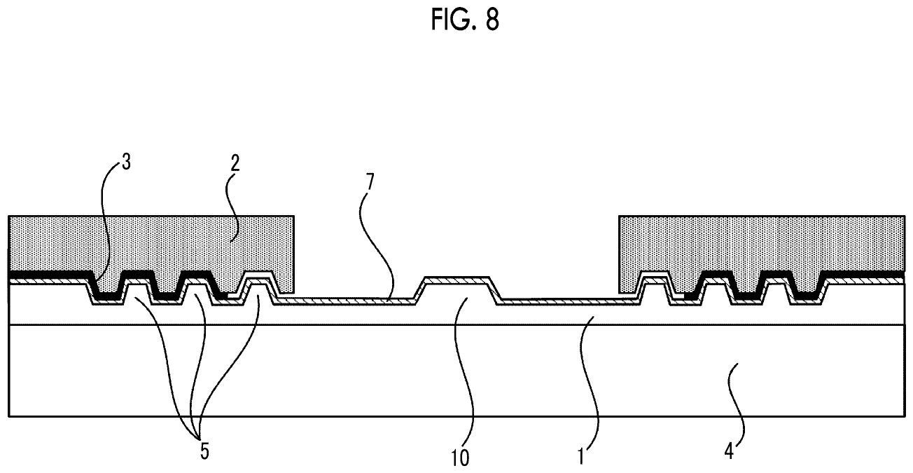

In FIGS. 3 to 7, the optical modulator having the electrode underlayer between the substrate 1 and the electrode 2 is shown as an example. However, as shown in FIG. 8, a buffer layer 7 may be provided between the substrate 1 and the electrode underlayer 3. In this case as well, the configurations shown in FIGS. 3 to 7 can also be adopted in combination.

In addition, in the above description, an example has been described in which the uneven portion is formed in the substrate on the lower side of the electrode 2 in the vicinity of the optical waveguide. However, the same uneven portion can also be formed on the end portion side of the electrode 2 away from the optical waveguide 10 in FIG. 1.

Next, an example in which the optical modulator of the present invention is adopted for an optical transmission apparatus will be described. The following description will be made by using an example of HB-CDM. However, without being limited to this example, the present invention can also adopt an optical phase modulator, an optical modulator having a polarization beam combining function, an optical modulator in which a larger or smaller number of Mach-Zehnder type optical waveguides are integrated, a device joined to an optical waveguide substrate including other materials such as silicon, a device used as a sensor, and the like.

As shown in FIG. 7, the optical modulator includes the optical waveguide 10 formed on the substrate 1 and the electrode (not shown) such as a modulation electrode that modulates the light wave propagating through the optical waveguide 10. The substrate 1 is accommodated in the case CA. Furthermore, an optical modulator MD can be formed by providing an optical fiber (F) for inputting the light wave to the optical waveguide and outputting the light wave from the optical waveguide. In FIG. 7, the optical fiber F is optically coupled to the optical waveguide 10 inside the optical waveguide device by using an optical block including an optical lens, a lens barrel, a polarization beam combining portion 6, and the like. The present invention is not limited to this configuration. The optical fiber may be introduced into the case via a through-hole that penetrates a side wall of the case. The optical fiber may be directly joined to an optical component or to the substrate, or the optical fiber having a lens function in an end portion of the optical fiber may be optically coupled to the optical waveguide inside the optical modulator. In addition, a reinforcing member (not shown) can be disposed and overlapped along the end surface of the substrate 1 to stably join the optical fiber or the optical block.

An optical transmission apparatus OTA can be formed by connecting an electronic circuit (digital signal processor DSP) that outputs a modulation signal SOL for causing the optical modulator MD to perform a modulation operation to the optical modulator MD. In order to obtain the modulation signal S applied to the optical modulator, it is necessary to amplify the modulation signal SOL output from the digital signal processor DSP. Therefore, in FIG. 11, the modulation signal is amplified by using a driver circuit DRV. The driver circuit DRV and the digital signal processor DSP can also be disposed outside the case CA, or can also be disposed inside the case CA. Particularly, a propagation loss of the modulation signal from the driver circuit can be further reduced by disposing the driver circuit DRV inside the case.

Input light L1 to the optical modulator MD may be supplied from the outside of the optical transmission apparatus OTA. However, a semiconductor laser (LD) can also be used as a light source as illustrated in FIG. 11. Output light L2 modulated by the optical modulator MD is output to the outside by the optical fiber F.

### INDUSTRIAL APPLICABILITY

As described above, according to the present invention, it is possible to provide an optical modulator that suppresses progressing of over-etching and that prevents an increase in a drive voltage and electrode peeling. Furthermore, it is possible to provide an optical transmission apparatus using the optical modulator.

### REFERENCE SIGNS LIST

1 substrate (thin plate, film body) on which optical waveguide is formed
2 electrode
3 electrode underlayer
4 reinforcing substrate
5, 50 protruding portion
10 optical waveguide
30 over-etching portion
F optical fiber
LD light source
CA case
MD optical modulator
DRV driver circuit
DSP digital signal processor
OTA optical transmission apparatus

1. An optical modulator comprising:
a substrate on which an optical waveguide is formed;
an electrode disposed close to the optical waveguide on the substrate; and
an electrode underlayer formed between the substrate and the electrode,
wherein a surface side of the substrate has an uneven portion in a predetermined range entering an inside of the electrode from an end portion of the electrode close to the optical waveguide when the substrate is viewed in a plan view.

2. The optical modulator according to claim 1,
wherein the optical waveguide is a rib-type waveguide.

3. The optical modulator according to claim 2,
wherein a maximum height of a protruding portion in the uneven portion is equal to or lower than a height of the rib-type waveguide.

4. The optical modulator according to claim 2,
wherein a maximum width of a protruding portion in the uneven portion is equal to or smaller than a width of the rib-type waveguide.

5. The optical modulator according to claim 1,
wherein two or more protruding portions are disposed in parallel in the uneven portion.

6. The optical modulator according to claim 1, further comprising:
a case that accommodates the substrate; and
an optical fiber that inputs a light wave to the optical waveguide, or outputs the light wave from the optical waveguide.

7. The optical modulator according to claim 6,
wherein the electrode is a modulation electrode for modulating the light wave propagating through the optical waveguide, and
an electronic circuit that amplifies a modulation signal to be input to the modulation electrode is provided inside the case.

8. An optical transmission apparatus comprising:
the optical modulator according to claim 7;
a light source that inputs a light wave to the optical modulator; and
an electronic circuit that outputs a modulation signal to the optical modulator.
